(19) United States
(12) Patent Application Publication
(10) Pub. No.: US 2013/0143422 A1
(43) Pub. Date: Jun. 6, 2013

(54) Power Connector

(71) Applicant: Samsung Electro-Mechanics Co., Ltd., Gyeonggi-do (KR)

(72) Inventors: Yoon Dong Kim, Gyeonggi-do (KR); Jae Cheol Joo, Daejeon-si (KR); Dong Jin Lee, Gyeonggi-do (KR)

(73) Assignee: Samsung Electro-Mechanics Co., Ltd., Gyeonggi-do (KR)

(21) Appl. No.: 13/691,044

(22) Filed: Nov. 30, 2012

(30) Foreign Application Priority Data
Dec. 1, 2011 (KR) 10-2011-0127738

(51) Int. Cl. H01R 13/648

(52) U.S. Cl. CPC H01R 13/648
USPC 439/108

(57) ABSTRACT

Disclosed herein is a power connector. The power connector includes a body, a power source terminal provided in the body, and connected with a power source line, a ground terminal provided in the body, and connected with a ground line, and an interference removal unit connected between the power source terminal and the ground terminal to remove electromagnetic interference. Here, a stop band filter is formed inside the power connector, so that parasitic component signals generated in the internal power source line are prevented from being transmitted as a constant power source even though a separate EMI filter is not formed inside the system.

In addition, noise signals included in the constant power source are removed, thereby realizing smooth power supply.

### CROSS REFERENCE(S) TO RELATED APPLICATIONS

This application claims the benefit under 35 U.S.C. Section 119 of Korean Patent Application Serial No. 10-2011-0127738, entitled “Power Connector” filed on Dec. 1, 2011, which is hereby incorporated by reference in its entirety into this application.

### BACKGROUND OF THE INVENTION

1. Technical Field

The present invention relates to a power connector, and more particularly, to a power connector which connects an external power source and a system (electronic equipment) with each other.

2. Description of the Related Art

All systems (electronic equipment) are operated by receiving power. In this instance, the operations of the systems differ in accordance with types (DC, AC, voltage, and current) of received power. Accordingly, it is significantly important to supply power suitable for the type of system.

In general, a system using AC constant power source such as 110V, 220V, and the like has a separate a power conversion device that converts the power into AC or DC power required for the system. The separate power conversion device may be implemented inside the system, or is manufactured as a separate device to be implemented outside the system, as long as required power is supplied to the system.

In particular, in order to readily apply, to the system, an external power source (general 110V and 220V AC constant power source) supplied in the power conversion device, a power connector is used.

When using the power connector, an internal power source line, an internal ground line, and the like which connect the power connector and the system are necessarily required. However, a parasitic inductance is generated in a conductor, and the like for connecting the power connector to the system, such that an EMI (Electromagnetic Interference) phenomenon occurs causing distortion of power supply.

### SUMMARY OF THE INVENTION

An object of the present invention is to provide a power connector in which stable power supply is possible by removing electromagnetic interference occurring due to the usage of the power connector.

According to an exemplary embodiment of the present invention, there is provided a power connector, including: a body; a power source terminal provided in the body and connected with a power source line; a ground terminal provided in the body and connected with a ground line; and an interference removal unit connected between the power source terminal and the ground terminal to remove electromagnetic interference.

Here, the interference removal unit may be a capacitor.

Further, the interference removal unit may be positioned inside or outside the body.

Also, the power connector may further include a ground connection unit electrically connecting the ground terminal to the outside of the body.

Furthermore, the body may include a latching unit fixing the body to an external case.

In addition, the power connector may further include a ground connection unit electrically connecting the ground terminal to the outside of the body. Here, the ground connection unit may be formed in a portion in which the latching unit and the external case are brought into contact with each other.

According to another exemplary embodiment of the present invention, there is provided a power connector, including: a body; a power source terminal provided in the body and connected with a power source line; a ground terminal provided in the body and connected with a ground line; and a ground connection unit electrically connecting the ground terminal to the outside of the body.

Here, the body may include a latching unit fixing the body to an external case.

Further, the ground connection unit may be formed in a portion in which the latching unit and the external case are brought into contact with each other.

Also, the power connector may further include an interference removal unit formed of a capacitor.

Furthermore, the interference removal unit may be positioned inside or outside the body.

### BRIEF DESCRIPTION OF THE DRAWINGS

FIG. 1 is a top view illustrating a power connector according to an exemplary embodiment of the present invention;

FIG. 2 is a front view illustrating the power connector of FIG. 1;

FIG. 3 is an equivalent circuit model of the power connector of FIG. 1;

FIG. 4 is a top view illustrating a general power connector;

FIG. 5 is a front view illustrating a general power connector;

FIG. 6 is an equivalent circuit model when a general power connector is used, and a separate EMI filter is present inside a system; and

FIG. 7 is a graph illustrating a case in which characteristics of the equivalent circuit model of FIG. 6 and characteristics of a power connector according to an exemplary embodiment of the present invention are simulated.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

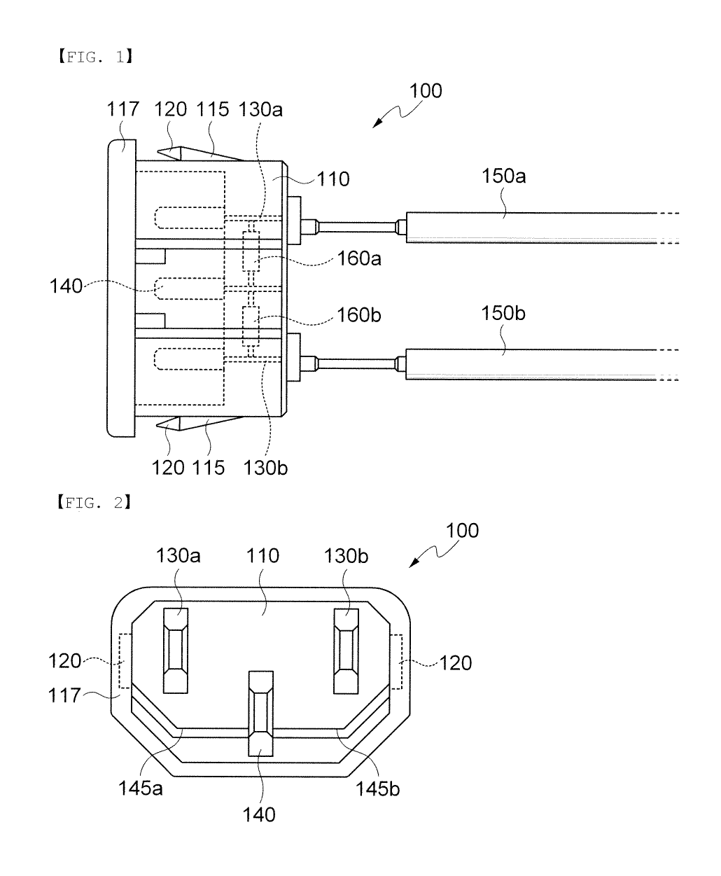

FIG. 1 is a top view illustrating a power connector according to an exemplary embodiment of the present invention, and FIG. 2 is a front view illustrating the power connector of FIG. 1.

Referring to FIGS. 1 and 2, a power connector 100 according to an embodiment of the present invention may include a body 110, power source terminals 130a and 130b, a ground terminal 140, and interference removal units 160a and 160b.

The body 110 is formed into a shape capable of being attached to an external case of a system, and the like, similar to a general power connector. More specifically, when an insertion hole corresponding to the body 110 is formed in the external case of the system, and then the body 110 is inserted into the insertion hole, a protrusion 117 is brought into contact with the external case so that the body 110 is supported. In addition, the external case is compressed by a latching unit 115 by the opposite surface of the external case, so that the body 110 is prevented from being separated from the external case.

Each of the power source terminals 130a and 130b is a portion directly connected with an external power source, and formed in the body 110. In addition, the ground terminal 140 is a portion directly connected with a ground of the external power source, and also formed in the body 110.

Meanwhile, the interference removal units 160a and 160b are connected between each of the power source terminals 130a and 130b and the ground terminal 140 to thereby remove electromagnetic interference. Here, each of the interference removal units 160a and 160b may be a capacitor.

In general, the capacitor is a device that mainly collects charges in electronic circuits, and vacuum capacitors, air capacitors, metalized paper capacitors, and the like may be used as the capacitor. The capacitor has a structure in which generally two metal plates serve as electrodes, and an insulator (dielectric) is positioned between the two metal plates. In addition, the interference removal units 160a and 160b are desirably provided inside the body 110 so as to be protected from an external environment, however, may be provided outside the body 110, as necessary.

Each of the number of interference removal units 160a and 160b and the number of power source terminals 130a and 130b has been described as being two. However, a case in which two phase power sources are used has been described as an example, the present invention is not limited thereto. Each of the number of interference removal units 160a and 160b and the number of power source terminals 130a and 130b may differ depending on a type of power source.

In addition, the power connector 100 according to an embodiment of the present invention may further include a ground connection unit 120 that electrically connects the ground terminal 140 and the outside of the body 110. The ground terminal 140 and the ground connection units 120 are electrically connected with each other by conductive materials 145a and 145b.

In this instance, when the external case is made of a metal material, the external case made of the metal material is connected with the ground of the system, and then the ground connection unit 120 is connected to the external case, the ground terminal 140 of the power connector 100 may be connected with the ground of the system.

Accordingly, since an internal ground line that is connected from the connector to the system is unnecessary, the power connector 100 may remove parasitic inductance generated in the internal ground line.

Here, the ground connection unit 120 may be formed at a portion in which the latching unit 115 and the external case of the system are brought into contact with each other. This is for electrical connection of the ground terminal 140 to the external case in a process of binding the power connector 100 to the external case of the system.

Accordingly, in the power connector 100 according to the present embodiment, a separate ground connection process is unnecessary, so that the ground terminal 140 and the ground of the system may be connected only by binding the power connector 100 to the external case of the system.

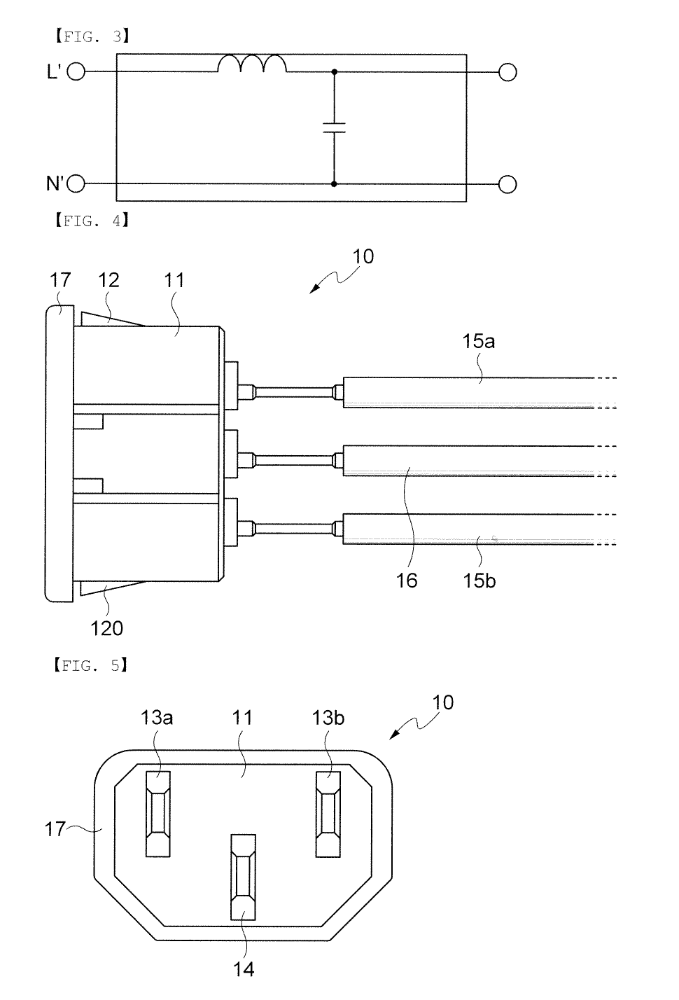

FIG. 3 is an equivalent circuit model of the power connector 100 according to the present embodiment. Here, L′ denotes internal power source lines 150a and 150b, and N′ denotes the ground terminal 140.

Referring to FIG. 3, in the power connector 100 according to the present embodiment, an internal ground line for connecting the connector to the system is unnecessary, so that parasitic inductance due to the internal ground line disappears, and a stop band filter may be formed by parasitic inductance generated in the internal power source lines 150a and 150b and the capacitor of the interference removal units 160a and 160b.

As for a principle in which the stop band filter is formed, low frequency signals pass but high frequency signals barely pass due to the parasitic inductance generated in the internal power source lines 150a and 150b.

The inductance signifies properties of interrupting a change in a current when the current flows in the conductor, and a value of the inductance is increased in proportion to a length of the conductor. In a case of AC current, a direction of the AC current is periodically changed, and the inductance interrupts a change in the AC current when the AC current flows in the conductor. Accordingly, corresponding to an increase in the value of the inductance, it becomes difficult for the high frequency signals to pass.

The partially passing high frequency signals are moved to the side of the interference removal units 160a and 160b which is formed of a capacitor, and brought into contact into the interference removal units 160a and 160b to thereby disappear.

As described above, the power connector 100 according to the present embodiment itself is formed as the stop band filter, and is operated as the EMI filter. That is, when stably supplying a power source by removing the internal ground line, the power connector 100 may simultaneously act as the EMI filter.

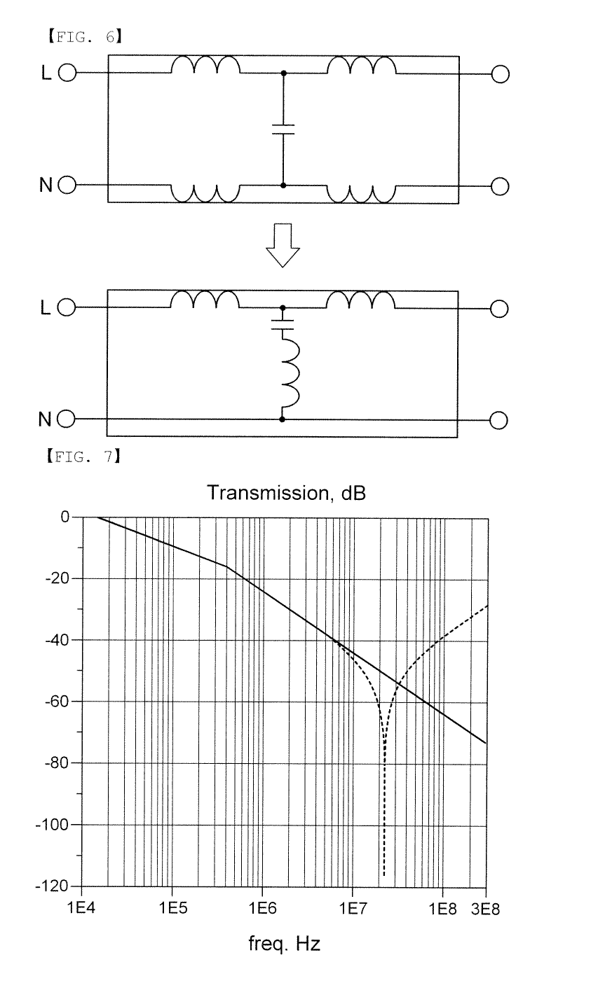

On the other hand, in a case of a general power connector, the power supply is significantly unstable due to the generation of parasitic inductance. FIG. 4 is a top view illustrating a general power connector, and FIG. 5 is a front view illustrating the power connector of FIG. 1.

As shown in FIGS. 4 and 5, two phase power source terminals 13a and 13b to which the external power source is connected, and the ground terminal 14 are positioned in a body 11 of a general power connector 10, and an external power source is supplied to the system through the power source terminals 13a and 13b and the ground terminal 14. The body 11 is formed into a shape capable of being bound to the external case, and the lie of the system.

Meanwhile, in the power connector 10, internal power source lines 15a and 15b for connecting the power source terminals 13a and 13b to the system, and the internal ground line 16 for connecting the ground terminal 14 to the ground of the system are further formed.

When a power conversion device is positioned inside the system, the internal power source lines 15a and 15b and the internal ground line 16 may be unnecessary, or may be formed to have a minimum length.

However, when the power conversion device is positioned outside the system, and the power connector 10 for the connection to an external power source is used, the internal power source lines 15a and 15b and the internal ground line 16 are necessary, and each length thereof may be lengthened. Accordingly, unintentional inductance components are generated in the internal power source lines 15a and 15b and the internal ground line 16.

FIG. 6 is an equivalent circuit model when a general power connector 10 is used, and a separate EMI filter is present inside a system. Referring to the equivalent circuit model shown in FIG. 6, the inductance generated in the internal power source line (L) acts as a factor that pulls noise around the system, and the inductance generated in the internal ground line (N) causes an increase in return pass inductance, resulting in an unstable power source.

That is, when the power connector for the supply of the external power source is used, the unintentional parasitic inductance is generated, and electromagnetic interference occurs, causing malfunction or failure of the system.

In order to overcome these problems, according to the present embodiment, the stop band filter is formed inside the power connector 100, so that EMI components generated in the internal power source lines 150a and 150b may be removed, thereby realizing smooth power supply.

FIG. 7 is a graph illustrating a case in which characteristics of the equivalent circuit model of FIG. 6 and characteristics of a power connector according to an exemplary embodiment of the present invention are simulated. As for conditions of the simulation, inductance of each of the internal power source lines 15a, 15b, 150a, and 150b is set as 10 nH, and a capacity of the capacitor (the interference removal unit) connected between the power source terminals 130a and 130b and the ground terminal 140 is set as 10 nF.

Referring to FIG. 7, a dotted line denotes characteristics (a general power connector is used, and a separate EMI filter is present in the system) of the equivalent circuit model shown in FIG. 6, and a solid line denotes characteristics of the power connector 100 according to the present embodiment. In the power connector 10 in the related art as shown in FIG. 7, it is found that, when a frequency exceeds 10 MHz, signals are no longer attenuated, and the signals are increased.

On the other hand, in the power connector 100 according to the present embodiment, it is found that signal attenuation characteristics are maintained until the frequency reaches 300 MHz.

As set forth above, according to the power connector of the embodiments of the present invention, the stop band filter is formed inside the power connector, so that parasitic component signals generated in the internal power source lines are prevented from being transmitted as a constant power source even though a separate EMI filter is not formed inside the system.

In addition, noise signals included in the constant power source are removed, thereby realizing smooth power supply.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. A power connector, comprising:
a body;
a power source terminal provided in the body, and connected with a power source line;
a ground terminal provided in the body, and connected with a ground line; and
an interference removal unit connected between the power source terminal and the ground terminal to remove electromagnetic interference.

2. The power connector according to claim 1, wherein the interference removal unit is a capacitor.

3. The power connector according to claim 1, wherein the interference removal unit is positioned inside or outside the body.

4. The power connector according to claim 1, further comprising:
a ground connection unit electrically connecting the ground terminal to the outside of the body.

5. The power connector according to claim 1, wherein the body includes a latching unit fixing the body to an external case.

6. The power connector according to claim 5, further comprising:
a ground connection unit electrically connecting the ground terminal to the outside of the body,
wherein the ground connection unit is formed in a portion in which the latching unit and the external case are brought into contact with each other.

7. A power connector, comprising:
a body;
a power source terminal provided in the body, and connected with a power source line;
a ground terminal provided in the body, and connected with a ground line; and
a ground connection unit electrically connecting the ground terminal to the outside of the body.

8. The power connector according to claim 7, wherein the body includes a latching unit fixing the body to an external case.

9. The power connector according to claim 8, wherein the ground connection unit is formed in a portion in which the latching unit and the external case are brought into contact with each other.

10. The power connector according to claim 1, further comprising: an interference removal unit formed of a capacitor.

11. The power connector according to claim 10, wherein the interference removal unit is positioned inside or outside the body.
